(19) United States
(12) Patent Application Publication
(10) Pub. No.: US 2014/0033880 A1
(43) Pub. Date: Feb. 6, 2014

(54) Wrench with Head Having Removable Segment

(71) Applicant: Terrence Hill, Greely (CA)

(72) Inventor: Terrence Hill, Greely (CA)

(21) Appl. No.: 13/666,307

(22) Filed: Nov. 1, 2012

(30) Foreign Application Priority Data
Jul. 31, 2012 (CA) 2784170

(51) Int. Cl. B25B 13/04

(52) U.S. Cl. 81/121.1

(57) ABSTRACT

The invention relates to a two-part wrench for engaging and rotating a fastening element. A first part consists of a torque-applying portion and the second part is separable from the first part. When disassembled, the wrench has open jaws that can engage a fastening element. The two parts of the wrench may then be assembled around the fastening element to form a closed-loop (or essentially closed loop) ring wrench to apply torque.

### CROSS REFERENCE TO RELATED APPLICATION

This application claims the benefit under the Paris Convention of Canadian Application No. 2,784,170, filed on Jul. 31, 2012. The contents of said application are incorporated herein by reference.

### FIELD OF THE INVENTION

The invention relates to a hand tool, and in particular a wrench for applying torque to a rotatable fastener such as a nut or bolt, with particular application for use when the fastener is located in a position where access may be difficult or impeded.

### BACKGROUND OF THE INVENTION

Wrenches for applying torque to a fastening element such as a nut, bolt or the like conventionally comprise a head for gripping the fastening element and a means to apply torque through the head to the fastening element. One type of conventional wrench comprises an open jaw having opposed flat jaws for gripping flat surfaces on a nut or other fastening element. Another type comprises a closed loop ring or box-end wrench in which the head encircles a fastening element and has grooves to grip projecting corners of a fastening element. A hybrid wrench may have a head that partially encircles the fastening element and has grooves similar to the ring wrench or flat facets, but has an open segment.

Various wrench designs exist for use in confined spaces, including the “crow's foot” wrench. A conventional crow's foot wrench consists of a solid body integral with a partially open wrench head. The wrench body includes a projecting tongue with an attachment means therein to engage a removable handle or other torque-applying means. Typically, the attachment means is a square socket, configured to fit the head of a socket wrench handle. A kit of several wrench heads can be supplied in different sizes to accommodate a range of bolt sizes, accompanied by a removable handle such as a ratchet handle. A crow's foot wrench has a generally planar configuration, with an oval or elliptical shape wherein the socket is at one end of the body and the jaw is at the opposing end.

The head of a crow's foot wrench partially encircles the fastening element, whereby the open segment of the head is narrower than the diameter of the internal head opening. As a result, in some applications it can be difficult to engage the fastening element if located in a confined space. This is particularly the case if the fastening element is connected to a large diameter hose or the like and cannot be accessed from above, as seen in the left-hand side of FIG. 1. A conventional spanner wrench can to some extent avoid this drawback since the jaws are fully open and the wrench can be inserted laterally (radially) onto the fastening element. However, the jaws consist of opposing flat surfaces that must grip opposing flat surfaces of the fastening element to apply torque; this can require a large space around the element to provide the proper positioning of the wrench—approximately 60 degrees of rotational space for rotating a conventional 6-sided nut. As well, in order to provide sufficient robustness to prevent deformation, the head should be relatively large. These and other factors can make it difficult to use these types of conventional wrenches in a confined space. For example, when working with a bank of closely-spaced hydraulic fittings or like, or if the hose diameter is too large to permit engagement with a conventional crows foot wrench, it can be necessary to disassemble the entire bank in order to access a single one of the fittings since a typical wrench that is sufficiently robust to be used with such fittings may be too large to fit in the tight space between fittings.

A wrench with improved suitability for use in a confined space can be provided with a ring wrench that has a closed ring-shaped head that fully encircles a bolt or nut. The closely-spaced grooves on the inside surface of this type of head provide an improved grip on the fastening element and reduces the possibility of stripping the sides of the element. As well, the grooved inner wall of the wrench head can grip the fastening element in a larger number of angular positions relative to an open jawed wrench, thereby improving its use in a confined space. Due to the structural integrity of this configuration, the head can also be thinner-walled and thus less bulky in its construction relative to an open-jaw wrench. However, as with a crow's foot wrench, a conventional ring wrench can only be used if the fastening element can be accessed from an axial approach (such as would be possible when accessing a vertical axis nut from above). A ring wrench cannot be used when access to the fastening element is blocked from axial approaches, in which case the fastening element must be engaged from the side. This situation arises, for example, when accessing the rotatable nut of a hydraulic line fitting in which an attached hose prevents one from slipping the ring wrench onto the nut from above.

### SUMMARY OF THE INVENTION

According to one aspect, the invention relates to a two-part wrench for engaging and rotating a fastening element. A first part consists of a torque-applying portion and a portion of a head integral therewith having open jaws to engage a fastening element. The second part is separable from the first part. When disassembled, the wrench can be brought into contact with a fastening element from a variety of directions including laterally or axially (for example to access the fastening element from above), depending on the position of the fastener and elements that may be joined to the fastener to limit access to it. The two parts of the wrench may then be assembled around the fastening element to form a closed-loop (or essentially closed loop) ring wrench to apply torque. In one aspect, the wrench comprises:

a wrench body comprising a torque-applying portion,

a yoke integral with said wrench body comprising opposing arms configured to partially encircle the fastening element, and

a closure member configured for assembly to the wrench body by engagement to at least one arm of the yoke, wherein when assembled the yoke and closure member form an eye for at least substantially encircling the fastening element for transmitting torque from the wrench to the closure member.

The yoke may comprise an essentially semi-circular inside face for contacting the fastening element.

The eye may be substantially ring-shaped to fully encircle the fastening element, in the manner of a ring wrench. The inside surface of the eye may be grooved to engage projecting corners of a fastening element.

There exist various means by which the closure member may be fastened to the wrench body to assemble the head into a functionally integral ring structure to engage and transmit torque to the fastening element. In one aspect, the closure member comprises opposing end segments, each of which engages a respective arm of the yoke for assembly. The end segments and yoke arms may comprise interlocking structures that are functionally integral for applying torque to a fastening element when rotated, but which can assemble by sliding together and can disassemble in the reverse fashion. The interlocking structure may comprise recessed surfaces within outer segments of said arms configured to engage corresponding recessed surfaces of the closure member defined by shoulders. The respective recessed surfaces can be defined by flat shoulders wherein the shoulders of the yoke and fastening element respectively contact each other when assembled to provide torque transfer between said wrench body and closure member.

Alternatively, the interlocking structures may comprise at least one U-shaped recess within said closure member and at least corresponding projection within said yoke configured to mate with said recess.

In another aspect, the arms define a first engagement surface at the base of the yoke and the closure member defines a second engagement surface, wherein when assembled said first and second engagement surfaces form a closed loop to encircle and engage the fastening element to transmit torque thereto. Preferably, the first and second engagement surfaces are substantially continuous when the wrench body and closure member are assembled, and comprise an array of grooves or other relief structure for engaging corners or other structure on the fastening element. The recessed surfaces that form the interlocking structures can be recessed relative to the respective engagement surfaces.

In another aspect, the invention relates to a kit of parts comprising at least one wrench as described herein and a lever arm configured to engage the torque-applying portion of the wrench body.

The term “fastening element” refers to any element or component that can be rotated by a wrench. Fastening elements are conventionally nuts or bolts, but may include other rotatable elements. A fastening element need not be used for fastening purposes, but may comprise a valve or other component that requires a torque-applying tool for rotation.

Directional references herein refer to the wrench in a horizontal position with the head being horizontally and projecting forward, for gripping a nut or other fastening element that projects upwardly with a vertical axis. Obviously, the wrench may be used in any orientation.

### BRIEF DESCRIPTION OF THE DRAWINGS

FIG. 1 is a perspective view of a bank of hydraulic fittings. A conventional crow's foot wrench 1 is depicted on the right-hand side, and a wrench 2 according to the present invention is depicted on the left-hand side of the structure.

FIG. 2 is a perspective view, from above, of a wrench according to the present invention, in the assembled position.

FIG. 3 is a wrench according to the invention, in an unassembled position.

FIG. 4 is a perspective view of the present wrench.

FIG. 5 is a further perspective view of the present wrench.

FIG. 6 is a plan view of the wrench, disassembled, with a portion of the handle not shown, to show underlying structure.

FIG. 7 is a plan view of a second embodiment of the invention.

FIG. 8 is a perspective view of a handle according to the second embodiment, in isolation from the wrench for clarity.

FIG. 9 is a plan view of a third embodiment of the invention, in assembled form.

FIG. 10 is a plan view of the embodiment of FIG. 9, disassembled.

FIG. 11 is a side view of the embodiment of FIGS. 7 and 8, disassembled, showing an extender portion of a conventional ratchet handle.

FIG. 12 is a further plan view of the embodiment of FIGS. 7 and 8, showing an extender portion of a ratchet handle.

FIG. 13 is a perspective view of the embodiment of FIGS. 7 and 8, assembled with a ratchet handle extender inserted therein.

FIG. 14 is a plan view of a fourth embodiment of the present invention, in the assembled position with the swivel handle in an open position.

FIG. 15 is a plan view of the fourth embodiment, with the handle in the closed position.

FIG. 16 is a plan view of the fourth embodiment with the closure member disassembled from the body.

### DETAILED DESCRIPTION

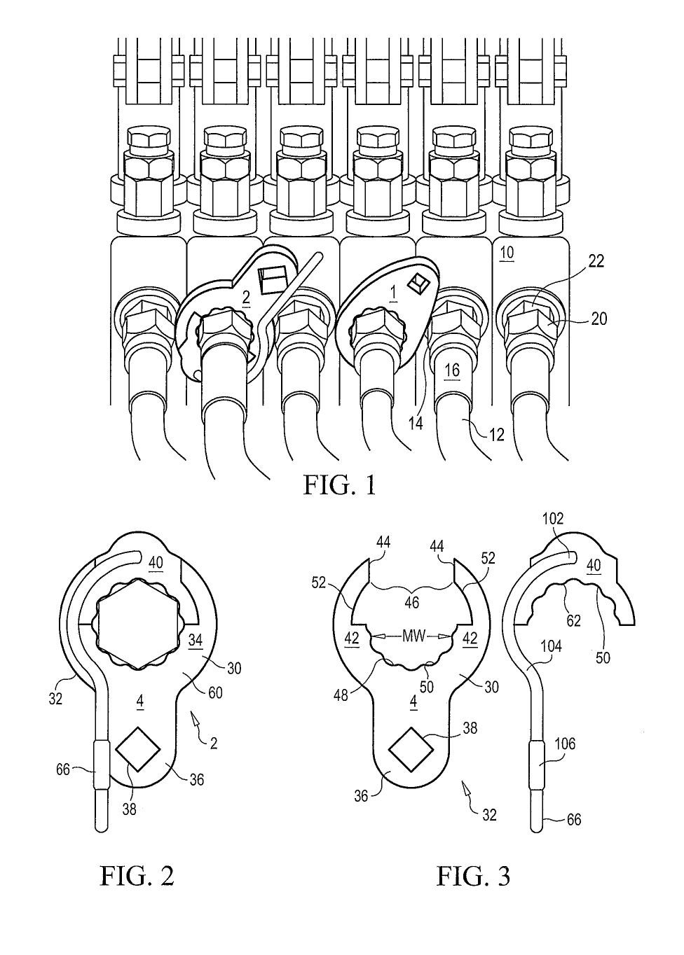

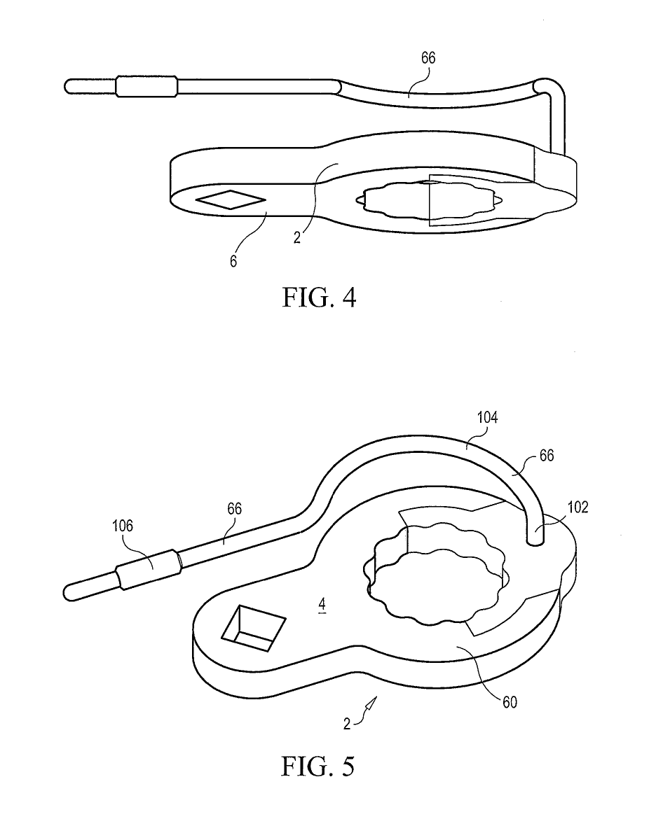

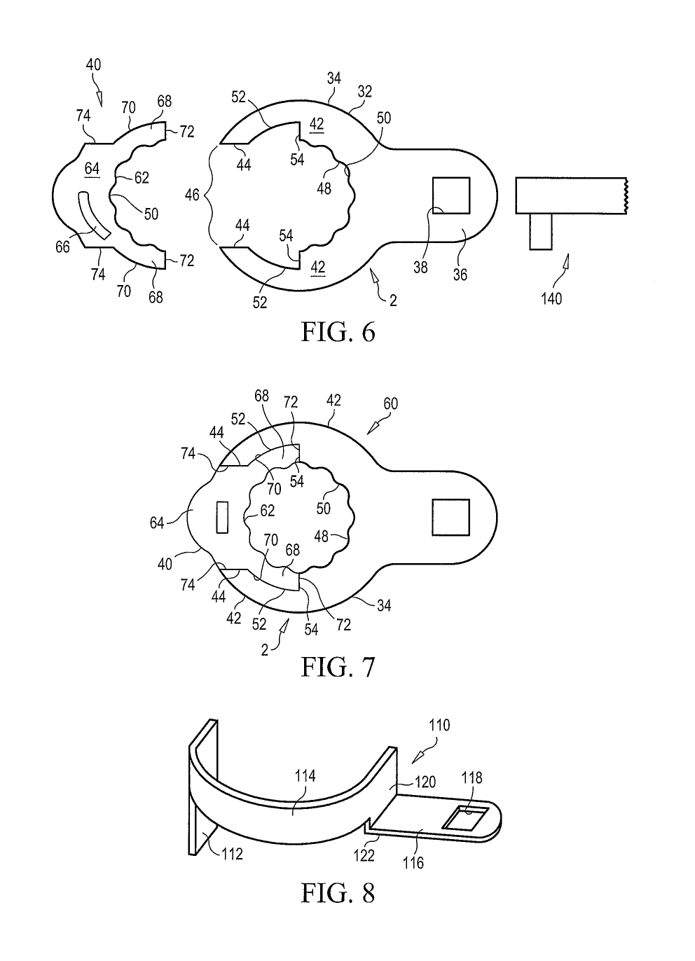

FIGS. 1-6 show a first embodiment of the invention. FIG. 1 shows this embodiment in use with a hydraulic system, for illustrative purposes. It is evident that the invention may be used to manipulate a wide variety of fastening elements for many applications. However, a hydraulic system is typical of the uses of the invention in that it requires accessing fastening elements in confined spaces.

FIG. 1 depicts a hydraulic fluid manifold 10, such as may form part of a typical hydraulic fluid supply system. Manifold 10 includes multiple individual hydraulic hoses 12 attached to manifold 10 in a closely spaced array. Each hydraulic hose 12 terminates in a fitting 14, having a socket 16 to receive the hose 12 and a rotatable nut 20 for fastening to an externally threaded opening 22 that projects from manifold 10. The foregoing system is merely illustrative of an application that includes fastening elements located in a confined space wherein it is difficult to use a conventional wrench. As is typical in such situations, the fittings 14 are closely spaced, with restricted spacing between adjacent nuts 20. As is evident from FIG. 1, a wrench has only limited room for manoeuvring when engaged to a nut in such a situation. The configuration of a conventional crow's foot wrench 1 limits its use in this situation, when a relatively large-diameter hose extends from the fastening element. In some cases, the only means by which the nut may be accessed with a conventional wrench is to serially unfasten all of the hydraulic fittings, so as to obtain clear access space around the given nut.

As further seen in the Figures, a wrench 2 according to the present invention comprises a wrench head 30 that when assembled forms a ring that fully encircles the nut 20 or other fastening element. This permits the use of a thinner (smaller outside diameter) head that can fit within a relatively confined space and that also provides an improved grip on the nut due to fully encircling the nut to grip all of its projecting corners.

Turning to FIGS. 2-6, an embodiment of a wrench 2 according to the present invention has a generally plate-like configuration that defines upper and lower flat surfaces 4 and 6. Wrench 2 comprises a wrench body 32 and a removable closure member 40. The wrench body 32 consist of an open yoke or jaw 34, comprising an open yoke-like structure, and a laterally-projecting tongue 36 that forms a torque-applying portion for rotation of wrench 2. A square socket 38 extends through tongue 36, configured to engage a conventional square head of a socket wrench handle or other lever arm for applying torque to the wrench 2. Yoke 34 consists of two symmetrically-opposing arcuate yoke arms 42 that each terminates at their free ends in flat surface 44 wherein the opposed flat surfaces 44 are spaced apart to leave a gap 46 between the opposing surfaces 44. The opposing flat surfaces 44 are parallel to each other and also parallel to an imaginary plane that bisects the wrench body. Yoke arms 42 define a semi-circular inner surface, the central portion of which at the base of the yoke forms grooved gripping surface 48 to engage a nut 20 or other fastening element. Grooves 50 on the gripping surface 48 are configured to engage the corners or other relief structure of a fastening element. Segments of yoke 34 at the respective ends of arms 42 define opposed engagement surfaces 52 for engaging the closure element 40, discussed below. Each engagement surface 52 is recessed from the gripping surface 48, wherein the recess is defined by a flat shoulder 54. Respective engagement surfaces 52 are opposed to each other and inwardly stepped from gripping surface 48. A nut or other fastening element can be positioned within the interior of yoke 34 to contact gripping surface 48. Engagement surface 52 is arcuate and smooth to contact a corresponding smooth arcuate surface of closure element 40.

Arms 42 define an essentially semi-circular shape wherein a segment is open to the forward end of wrench 2 by an amount generally equal to the maximal internal opening of wrench head 30. In different embodiments, the opening is either greater than or lesser than the maximal internal opening of wrench head 30. When the opening between arms 42 is equal to or greater than the maximal internal opening, arms 42 do not obstruct the engagement of wrench 2 with a fastening element when wrench 2 is brought into engagement with a fastening element from a lateral (radial) approach. This is shown in FIG. 3, wherein the line MW represents the maximal spacing between opposite portions of gripping surface 48 of yoke 34. As will be seen, when the wrench is assembled, MW laterally bisects the circular interior the wrench head, and thus falls on a diameter of this circle and represents the maximum width of the wrench opening. In one embodiment, the spacing 46 between surfaces 44 of the yoke arms is at least equal to distance MW, thus permitting the wrench to be inserted onto a nut 20 from a radial direction of approach, wherein the ends of the respective arms 42 do not interfere with the external surface of the nut. In other embodiments, spacing 46 may be greater or less than distance MW.

Removable closure member 40 can be assembled onto wrench body 32 to form a closed, ring-shaped head 60 having a circular eye that encircles and engages a fastening element 20. Closure member 40 may be fully separable from the wrench body 32, wherein the wrench comprises two fully separable elements. Alternatively, closure member 40 may be retained to the wrench body 32 by a retainer that allows free movement of the closure member relative to the wrench body, such as a flexible tether (not shown), to prevent inadvertent loss of the closure member. Closure member 40 comprises an essentially semi-circular inside gripping surface 62, having vertical grooves or a similar structure similar to the gripping surface 48 of the yoke. The closure member further comprises a central body 64 to which a handle 66 is attached, described below, and opposing arcuate arms 68 on opposing sides of the body 64. The body and arms form a monolithic member, wherein the inside gripping surface 62 is continuous on the body and arms and forms a continuous semicircular wall. Each arm 68 has a curved, smooth external surface 70, that mates with the closure member engagement surface of the yoke, when assembled. Each arm 68 of the closure member 40 terminates in a flat end surface 72. The body portion of the closure member comprises opposing flat sidewalls 74 that are parallel to each other.

Closure member 40 is configured to be engaged to wrench body 32 whereby when assembled, yoke 34 and closure member 40 form a structurally integral ring-shaped head that can transmit torque to a fastening element when rotated. In particular, the closure member 40 can slide into engagement with the wrench body 32, via an axial direction of approach. When thus engaged, the respective flat surfaces of the yoke and closure member are in contact whereby the closure member and yoke form an essentially circular ring. In particular, the flat shoulders 54 of the yoke are in contact with flat end surfaces 72 of the closure member arms 68. The plane of engagement of these respective surfaces substantially falls on a plane that bisects the wrench head opening. In addition, the opposed flat end surfaces 44 of the yoke arms 42 engage opposing side wall surfaces 74 of the closure member 40. The closure member body 64 is configured to fit snugly between the yoke arms 42, whereby the closure member 40 may be easily assembled to the wrench body but is restricted in its movement relative to wrench body 32 when assembled thereto. The resulting structure forms a functionally integral and robust ring-shaped head that does not inadvertently disassemble or misalign when gripping a nut or other fastening element. In other embodiments, described below, the closure member 40 and body 32 are effectively locked together to form a monolithic unit when a ratchet wrench handle is inserted into aligned openings in the closure member 40 and body 32 respectively.

It will be seen that the respective mutually engaging flat surfaces of the respective members can alternatively be non-flat or non-parallel if desired.

The closure member 40 may be assembled to yoke 34 by inserting the closure member onto the yoke from an axial approach. Thus, if wrench 2 is horizontal, closure member 40 may be inserted onto the yoke from above. When assembled, wrench body 32 and closure member 40 form an aligned, essentially planar structure. The respective gripping surfaces 48 and 62 are essentially continuous when assembled, and define an essentially circular inner surface that forms the wrench eye. Inner surfaces 48 and 62 both have vertical grooves or depressions 50 or other evenly spaced relief structure to engage the corners of a nut or other fastening element. It will be seen that depending on the nature of the fastening element that the wrench is intended to engage, the inside surface of the eye may comprise essentially any type of relief structure that engages the exterior of a fastening element. In some cases, engagement may be provided by frictional means, whereby surfaces 48 and 62 are substantially smooth but provided with a high frictional coefficient. The respective surfaces 48 and 62 comprise mirror-image semi-circles. However, it will be seen that with modifications, the respective proportions may change whereby either of these elements may form less or more than a full semi-circle. As well, the essentially circular configuration of the eye may be varied for specialized applications.

The configuration of wrench body 32 and closure member 40 permits transmission of torque from wrench body 32 to closure member 40. In particular, as wrench body 32 is torqued by rotation of tongue 36 (preferably using an external handle such as a ratchet wrench handle) respective flat surfaces 44 and 74 and 54 and 72 described above are brought to bear against each other, whereby torque applied to wrench body 32 is transmitted to closure member 40, thereby permitting the even application of rotational force to the full outside surface of a nut or other fastening element. The respective pairs of flat surfaces 44 and 74 on the one hand and 54 and 72 on the other hand are disposed at right angles to each other for effective torque transfer. Wrench body 32 and closure member 40, when engaged together, functionally form a wrench having a closed and structurally rigid and integral ring-shaped head.

A handle 66 protrudes outwardly from closure member 40 to permit the user to easily grip and manipulate the closure member for assembly of the wrench. As seen in FIGS. 2-6, handle 66 may comprises a curved rod that has a first leg 102 extending upwardly from the body of the closure member, merging with a horizontal arcuate portion 104 that generally follows the contours of the arms of the closure member and yoke, and a protruding grip portion 106 extending laterally. In other embodiments, not shown, the handle may be omitted or be detachable from closure member 40.o

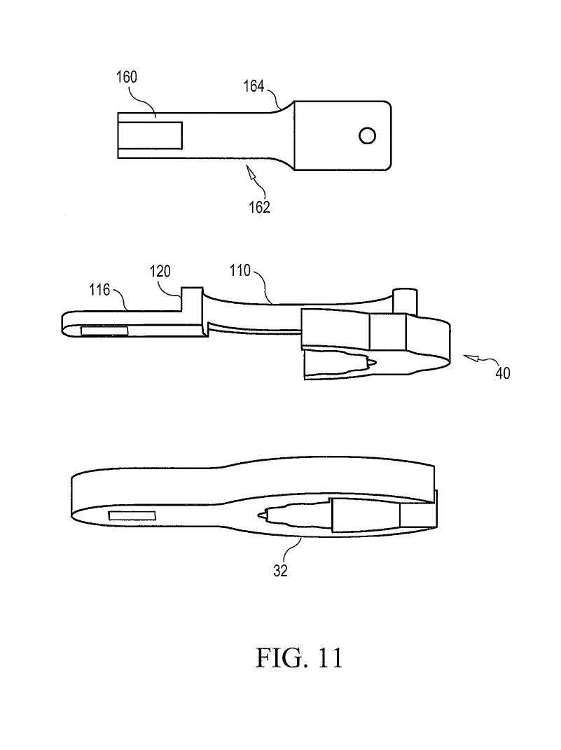

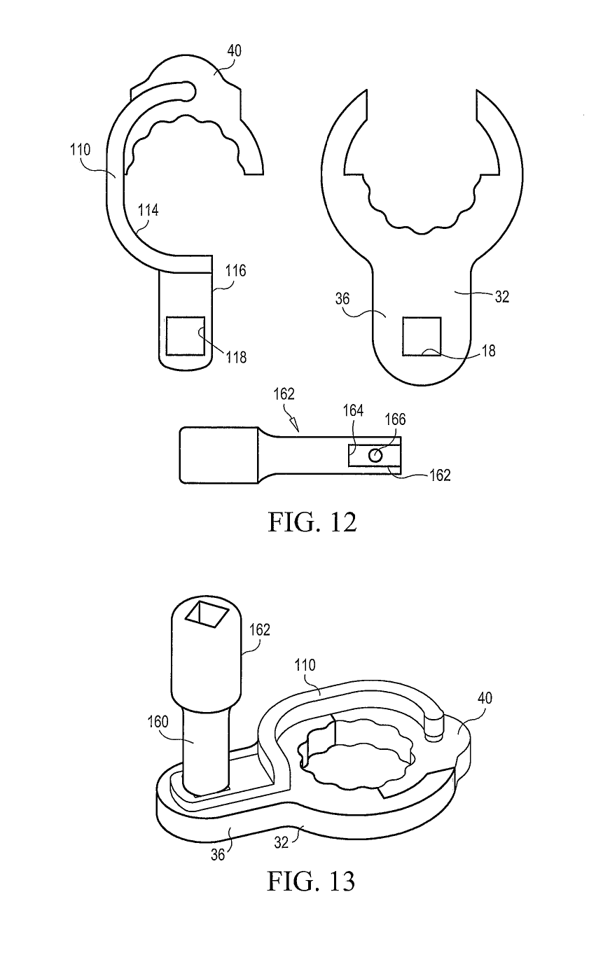

A second embodiment of the handle is shown in FIGS. 7, 8 11, 12 and 13. Figures show 7 and 8 handle 110 separated from closure member 40 for clarity; normally, handle 110 would be permanently attached to closure member 40, as seen in FIGS. 11-13, and either fixed or swivelling relative to closure member 40 In this embodiment, handle 110 comprises a curved plate having an upright leg 112 connecting with closure member 40, an arcuate segment 114 and a flat grip portion 116 for gripping the handle. A rectangular opening 118 may be provided within grip portion 116 to engage a ratchet wrench handle or other arm to assist manipulation of handle 110. Grip portion 116 is dropped relative to arcuate segment 114 by downward leg 120. Grip portion 116 is positioned whereby lower surface 122 thereof contacts an upper surface of tongue 36 when the closure member is assembled to body 32 and is horizontally aligned therewith. As a result, handle 110 serves the dual functions of a handle for closure member 40 and a stop to limit travel of closure member 40 relative to body 32 and to thereby maintain alignment of these members when assembled.

As seen in more detail in FIGS. 11-13, the rectangular openings 18 in wrench body 32 and 118 and handle are aligned when closure member 40 is assembled with body 32. These openings are configured to fit the square shaft 160 of a conventional ratchet wrench or ratchet wrench extender 162 as seen in FIGS. 11-13, wherein shaft 160 can be inserted within both openings when engaged with the assembled wrench. Ratchet wrench shaft 160 terminates in a shoulder 164. When fully inserted into aligned openings 18 and 118, shoulder 164 abuts the upper surface of grip portion 116 thereby preventing upward movement of grip portion 116. This effectively locks wrench body 32 and closure member 40 together. Shaft 160 normally has a spring-loaded bearing 166 that retains shaft 160 within openings 18 and 118.

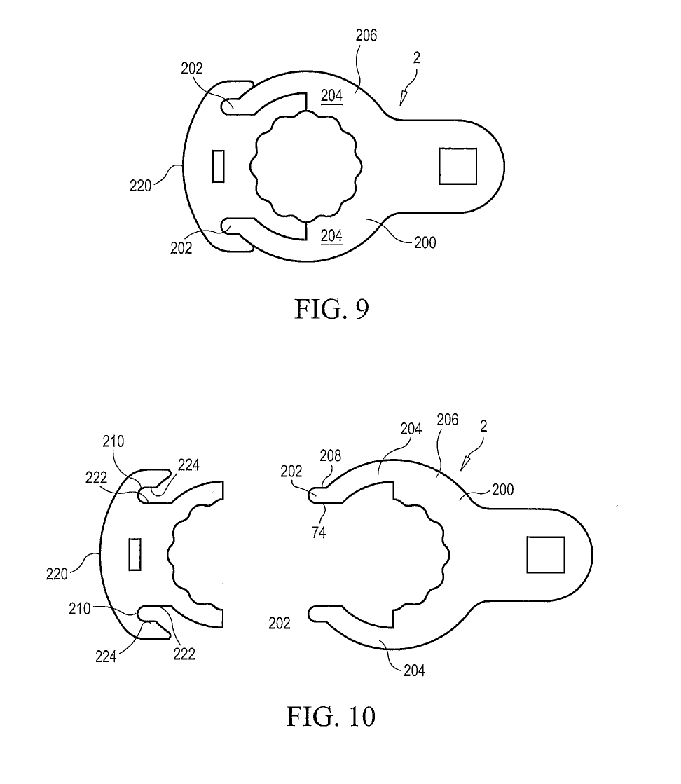

FIGS. 9 and 10 illustrate a further embodiment of the invention. In this embodiment, body 200 comprises interlock members 202 projecting forwardly from the end of each arcuate arm 204 of yoke 206. Interlock members 202 each comprise a sidewall 208 that diverges outwardly from end wall 74, wherein interlock members 202 each fit within corresponding recesses 210 in closure member 220. Recesses 210 comprise converging sidewalls 222 and 224 that permits recesses to interlock with members 202 and can serve to further restrict relative movement between body 200 and closure member 220 when assembled. The handle portion of closure member 220 is omitted for clarity, but may comprise the same structure as in FIGS. 7, 8 and 11-13.

In general, it will be seen that a variety of handle configurations may be provided, although it is desirable to configure the handle so as to provide minimal interference with the operation of the wrench.

In use, a user initially separates closure member 40 from wrench body 32, if these are not already separated. Wrench body 32 is then positioned against a fastening element 20 with a lateral (radial) movement of wrench body 32, whereby the opposed arms 42 of yoke 34 are positioned alongside opposing sides of the fastening element 20 so as to partially encircle fastening element 20. Closure member 40 is then assembled to wrench body 32 by vertically aligning the closure member 40 with the wrench body 32 and sliding member 40 downwardly onto yoke 34 to engage these components together. As described above, the body 32 and closure member 40 are effectively locked together when a socket wrench shaft is inserted into aligned openings 18 and 118. When thus engaged, the respective gripping surfaces of yoke 34 and closure member 40 form a ring-shaped eye that fully encircles the fastening element 20 and which will remain assembled until the closure member 40 is removed from yoke 34. Assuming that the size of wrench 2 has been properly selected, the inside surface of the wrench head snugly engages corners or other relief structure of the fastening element, whereby torque applied to the wrench will be transmitted to the fastening element without slippage. In order to apply torque to wrench 2, a wrench handle or other lever arm 140 can be engaged to the wrench body.

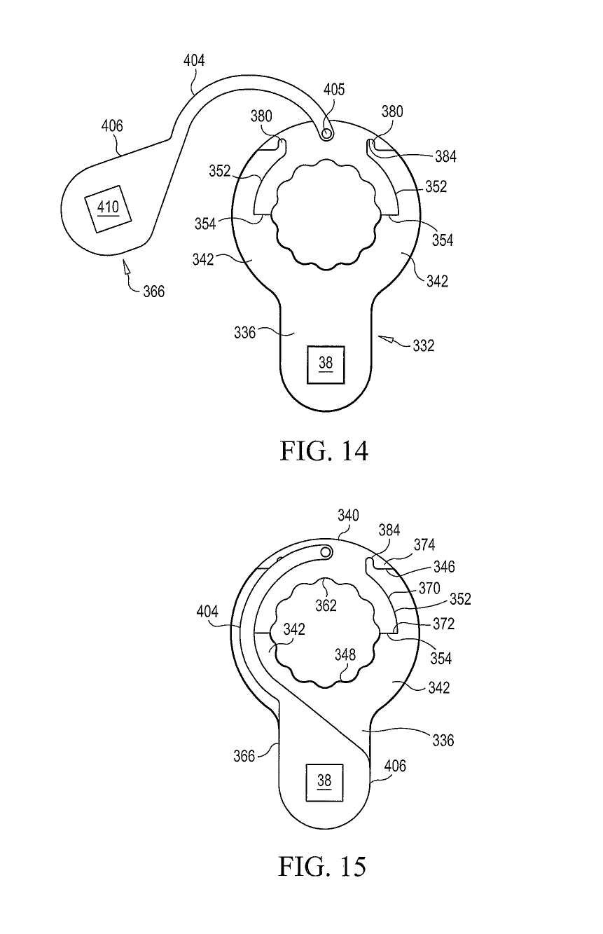

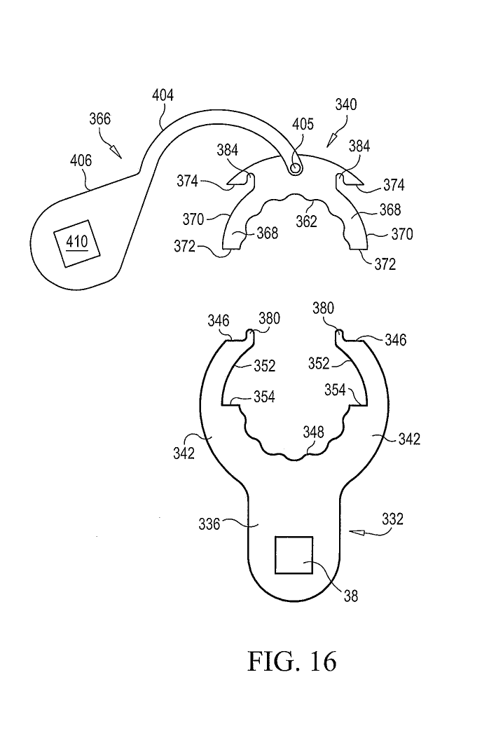

FIGS. 14-16 illustrate a fourth embodiment of the invention. The yoke arms 342 of body 332 each comprise a curved, recessed engagement surface 352, inwardly stepped from gripping surface 348 at a flat shoulder 354. Arms 342 each terminate at their free ends in a projecting lip 380, one face of which is continuous with surface 352 and the opposed face of which is inwardly stepped from the exterior surface of arm 342 at a flat shoulder 346. Closure member 340 comprises an internal gripping surface 362 that when assembled is continuous with gripping surface 348 of body 332. Closure member 340 comprises opposed arms 368, each with an external surface 370 that contacts engagement surface 352 of yoke arms 342 when assembled and flat end surfaces 372. Surfaces 370 are each continuous with a groove 384 that conforms to the shape of lip 380, wherein lips 380 may be inserted within grooves 384 for assembly of closure member 340 with body 332. Closure member 340 has opposed flat shoulder surfaces 374 adjacent the exterior mouth of each groove 384, configured to contact an opposed flat surface 346 at the end of each yoke arm 342 adjacent lip 380. When assembled, respective flat surfaces 354 and 372 engage each other, as well as respective flat surfaces 346 and 374.

Body 332 further comprises a square socket 38 to receive the head of a socket wrench.

Closure member 340 is provided with a handle 366 for gripping and manipulating the closure member to assemble the closure member to body 332. Handle 366 comprises a plate having a curved arm 404 that is pivotally engaged to the upper surface closure member 340 intermediate the respective ends thereof. The pivotal engagement may comprise a rivet, pin or other convenient rotatable or pivotal engagement means, wherein handle 366 pivots horizontally above the upper surface of body 332 and closure member 340. The curvature of arm 404 is configured to match the curvature of the underlying portion of closure member 340 and yoke arm 342. Arm 404 terminates an enlarged plate-like end portion 406 having a configuration that essentially matches the underlying tongue 336 of body 332. Portion 406 may overhang tongue 336 to permit manipulation of handle 366. A square opening 410 in portion 406 is provided which aligns with socket 38 when handle 366 is rotated into alignment with body 332. Handle 366 contacts the upper surface of body 332 to retain closure member 340 in alignment with body 332 and prevent slippage below the plane of body 340. As described above, closure member 340 is effectively locked to body 340 when a socket wrench shaft or similar member is inserted within aligned openings 38 and 410.

In use, body 332 can be engaged with a fastening element in the same fashion as the previous embodiments. Closure member 340 can be manipulated into alignment with body 332 by pivoting the closure member relative to handle 366 if required, and assembling closure member 340 with body 332 when aligned. Opening 410 in handle 366 is aligned with socket 38 and a socket wrench is inserted into these aligned openings to apply torque to the wrench, and also to lock the body and closure member together.

The present invention may be supplied as a kit of parts, consisting of multiple wrenches 2 for different size fastening elements. For such a kit, it is preferable that the multiple wrenches be configured to fit a single handle or other lever arm 140. The kit may include any type of appropriate lever arm 140 that fits wrench bodies 32.

The wrench may be fabricated from any suitable material, such as tool-quality steel. The wrench may be fabricated by casting, machine tooling from a blank, or any other suitable manufacturing process. It will be further seen that the overall and relative dimensions of the present invention may vary considerably depending on the desired application. For example, dimensions such as the thickness and depth of the wrench body and related components may be varied depending on the desired application.

The scope of the claims should not be limited by the preferred embodiments set forth in the examples, but should be given the broadest interpretation consistent with the description as a whole. The claims are not to be limited to the preferred or exemplified embodiments of the invention.

What is claimed is:

1. A wrench for engaging and rotating a fastening or other rotatable element, comprising:
a wrench body comprising a torque-applying portion,
a yoke integral with said wrench body comprising opposing arms configured to partially encircle the rotatable element, and
a closure member configured for assembly to the wrench body by engagement to at least one arm of the yoke or disassembly from the wrench body, wherein when assembled the yoke and closure member form an eye for substantially encircling the fastening element for transmitting torque from the wrench to the closure member.

2. The wrench of claim 1 wherein the eye is substantially ring-shaped to fully encircle the fastening element.

3. The wrench of claim 1 wherein the closure member comprises opposing end segments, each of which engages a respective arm of the yoke for assembly.

4. The wrench of claim 3 wherein said end segments and yoke arms comprise interlocking structures open to a side of the wrench body to permit assembly by sliding the closure member onto the wrench body from said side.

5. The wrench of claim 4 wherein said interlocking structures comprise recessed surfaces within said arms configured to engage respective recessed surfaces of the closure member.

6. The wrench of claim 5 wherein said interlocking structures further opposing surfaces on said yoke and closure member respectively configured to contact each other when assembled, said surfaces comprise two pairs of opposing surfaces wherein each pair of surfaces is angularly disposed relative to the other of said pair of surfaces.

7. The wrench of claim 6 wherein said surface pairs comprise at least one recessed shoulder within one of said yoke and closure member and an end surface of the other of said yoke and closure member.

8. The wrench of claim 1 wherein said arms define a first engagement surface at the base of the yoke and the closure member defines a second engagement surface, wherein when assembled said first and second engagement surfaces engage the fastening element to transmit torque thereto.

9. The wrench of claim 8 wherein said first and second engagement surfaces are substantially continuous when the wrench body and closure member are assembled.

10. The wrench of claim 8 wherein the first and second engagement surfaces comprise a relief structure for engaging said fastening element.

11. The wrench of claim 1 further comprising a stop member to retain the closure member in alignment with the yoke when assembled.

12. The wrench of claim 11 wherein said stop member comprises a projection from said closure member, said projection having a lower surface that contacts said body when the closure member and body are aligned.

13. The wrench of claim 11 wherein said projection further comprises a handle for gripping the closure member.

14. The wrench of claim 12 wherein said projection and said body comprise openings which are aligned when the closure member and body are assembled, said openings configured to engage a shaft from a lever arm for locking together the respective closure member and body when engaged with the shaft of a lever arm extending through said openings.

15. A kit of parts comprising at least one wrench according to claim 1 and a lever arm configured to engage the torque-applying portion of the wrench body.
